(19) United States
(12) Patent Application Publication
(10) Pub. No.: US 2015/0104305 A1
(43) Pub. Date: Apr. 16, 2015

(54) FAN ASSEMBLY AND FASTENER THEREOF

(71) Applicants: INVENTEC CORPORATION, Taipei (TW); Inventec (Pudong) Technology Corporation, Shanghai (CN)

(72) Inventors: Hung-Che HUANG, Taipei (TW); Chung-Chien WU, Taipei (TW)

(73) Assignees: INVENTEC CORPORATION, Taipei (TW); Inventec (Pudong) Technology Corporation, Shanghai (CN)

(21) Appl. No.: 14/207,031

(22) Filed: Mar. 12, 2014

(30) Foreign Application Priority Data
Oct. 11, 2013 (CN) 201310472967.5

(51) Int. Cl. F04D 29/64; F16B 21/02; F16B 19/02

(52) U.S. Cl. CPC F04D 29/646; F16B 19/02; F16B 21/02
USPC 415/213.1; 403/220

(57) ABSTRACT

A fastener includes a main body and a bending body. The main body includes a protrusion section and an extension section. The extension section is connected with the protrusion section. The bending body is connected with the extension section of the main body. The bending body includes a first plate and a second plate. The first plate is connected with the extension section. The second plate is connected with the first plate. An angle is formed between the first plate and the second plate. The second plate has a first surface and a second surface which is opposite to the first surface. The first surface faces toward the main body, and the second plate has a first rib protruding from the second surface.

### CROSS-REFERENCE TO RELATED APPLICATIONS

This non-provisional application claims priority under 35 U.S.C. §119(a) on Patent Application No(s). 201310472967.5 filed in China on Oct. 11, 2013, the entire contents of which are hereby incorporated by reference.

### TECHNICAL FIELD

The disclosure relates to a fan assembly and a fastener thereof, more particularly to a fan assembly and its fastener with better vibration absorbing capability.

### BACKGROUND

The operation speed of electronic components is continuously increased with the advance of science and technology. For example, the operation speed of the server is significantly getting faster than before. However, the rising operation speed of the server leads to the increase of the heating power of the server. In order to prevent the overheat of the server which causes the electronic components inside the server temporary or permanent failure, a heat dissipating module is essential to be disposed inside the server for dissipating the heat generated by the electronic components out of the server.

A fan module is generally disposed inside the server for dissipating heat from electronic components. Specifically, cool air is drawn into the server by the fan module, or the heated air is removed from the server. Thereby, the heat is dissipated from the server. However, serious vibration or shaking is generated by the fan module when the fan module operates, which leads to the electronic components inside the server to fail or breakdown.

### SUMMARY

An embodiment of the disclosure provides a fastener comprising a main body and a bending body. The main body comprises a protrusion section and an extension section. The extension section is connected with the protrusion section. The bending body is connected with the extension section of the main body. The bending body comprises a first plate and a second plate. The first plate is connected with the extension section. The second plate is connected with the first plate. An angle is formed between the first plate and the second plate. The second plate has a first surface and a second surface which is opposite to the first surface. The first surface faces toward the main body, and the second plate has a first rib protruding from the second surface.

An embodiment of the disclosure provides a fan assembly comprising a framework, at least a fan and a fastener. The frame work includes at least a perforation. At least a fan is located on the frame work. Each of the fans has at least a mounting hole which is corresponded to the at least a perforation. The fastener penetrates the perforation and the mounting hole such that the at least a fan is securely located on the frame work.

The fastener comprises a main body and a bending body. The main body comprises a protrusion section and an extension section. The extension section is connected with the protrusion section. The bending body is connected with the extension section of the main body. The bending body comprises a first plate and a second plate. The first plate is connected with the extension section. The second plate is connected with the first plate. An angle is formed between the first plate and the second plate. The second plate has a first surface and a second surface which is opposite to the first surface. The first surface faces toward the main body, and the second plate has a first rib protruding from the second surface.

### BRIEF DESCRIPTION OF THE DRAWING

The present disclosure will become more fully understood from the detailed description given hereinbelow, along with the accompanying drawings which are for illustration only, thus are not limitative of the present disclosure, and wherein:

FIG. 1A is a perspective view of a fastener according to an embodiment of the disclosure;

FIG. 1B is a front view of the fastener described in FIG. 1A;

FIG. 1C is a side view of the fastener described in FIG. 1A;

FIG. 2A, FIG. 2B and FIG. 2C are perspective views of the fastener according to other embodiments of the disclosure;

FIG. 3A is a perspective view of a fan assembly according to other embodiments of the disclosure;

FIG. 3B is a partially sectional view of the fan assembly described in FIG. 3A;

FIG. 3C is a partially enlarged view of the fan assembly described in FIG. 3B; and

FIG. 4 is a partially sectional view of a server according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

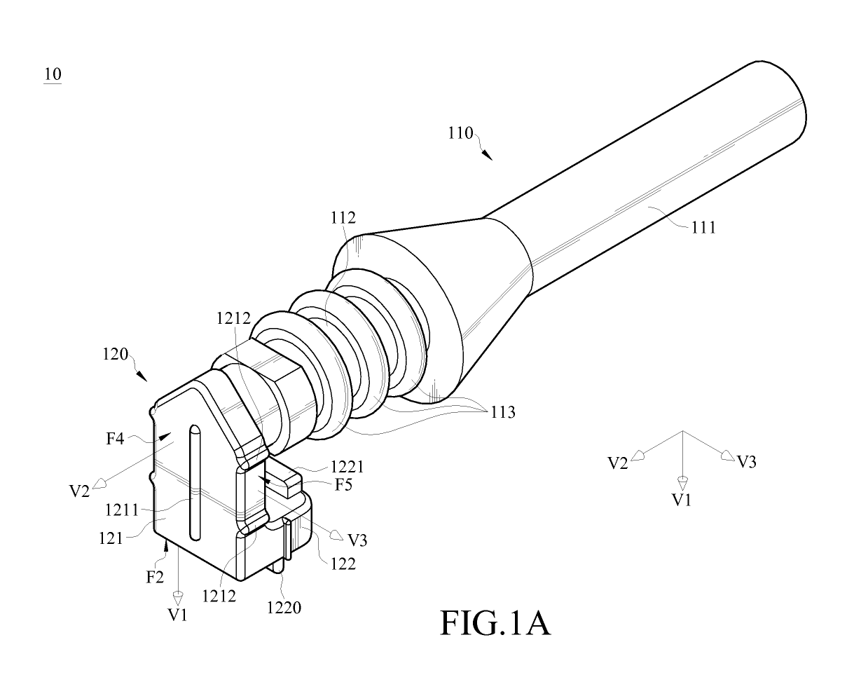

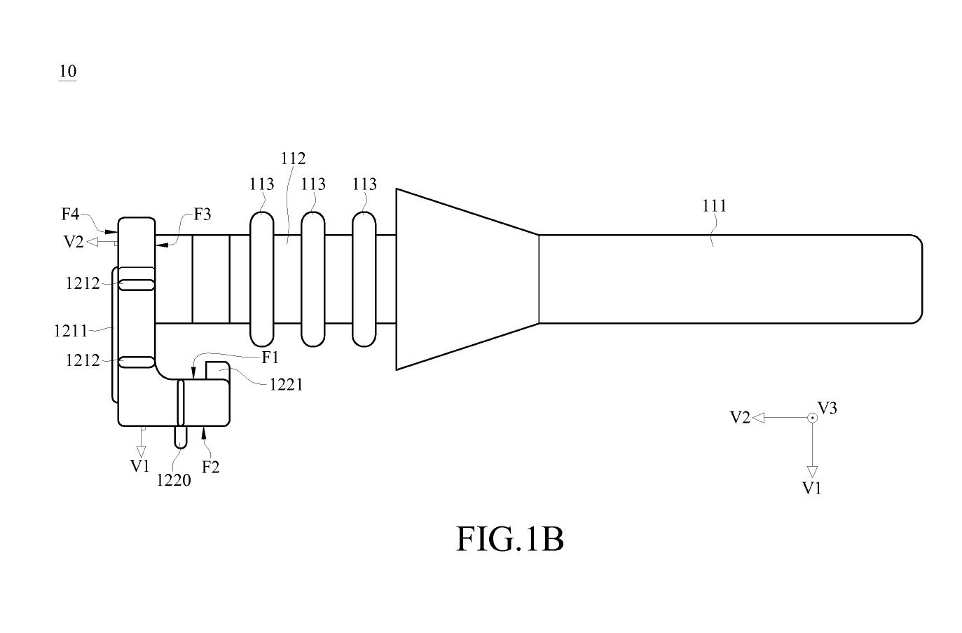

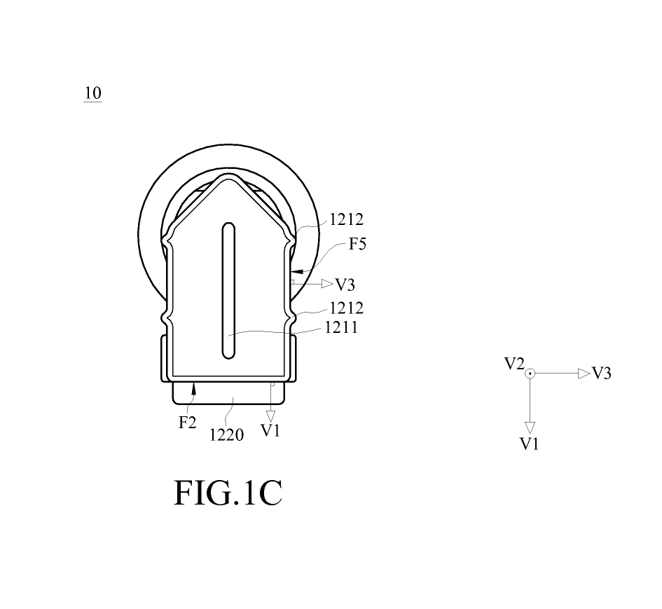

Please refer to the FIG. 1A, FIG. 1B and FIG. 1C, FIG. 1A is a perspective view of a fastener according to an embodiment of the disclosure. FIG. 1B is a front view of the fastener described in FIG. 1A. FIG. 1C is a side view of the fastener described in FIG. 1A.

A fastener 10 comprises a main body 110 and a bending body 120 which is connected with the main body 110. The material of the fastener 10 is adapted for vibration absorption. Therefore, the fastener 10 is disposed into a fan assembly for preventing a part of vibration generated by the operation of a fan from being transferred to the components inside the fan assembly or a server, which absorbs the energy of vibration. In this embodiment, the main body 110 comprises a protrusion section 111 and an extension section 112 which is connected with the protrusion section 111. The protrusion section 111 is located at one side of the main body 110 which is far from the bending body 120, thus, the protrusion section 111 and the extension section 112 are located on the two opposite sides of the main body 110, respectively. Moreover, at least a thread 113 protrudes from a surface of the extension section 112. In this embodiment, the number of the threads 113 is three, and the thread 113 is a ring-shaped structure that covers the partial surface of the extension section 112, but the number and the shape of the thread 113 in this disclosure is not limited thereto.

The bending body 120 comprises a first plate 121 and a second plate 122 which is connected with the first plate 121. The first plate 121 is connected with the main body 110. In this embodiment, an angle is formed between the first plate 121 and the second plate 122. It is noted that the angle between the first plate 121 and the second plate 122 is neither zero degree nor 180 degrees. In other words, the extending direction of the first plate 121 is not parallel to or does not coincide to that of the second plate 122.

The second plate 122 has a first surface F1 and a second surface F2 which is opposite to the first surface F1. The first surface F1 faces toward the main body 110, and the second plate 122 comprises a first rib 1220 protruding from the second surface F2. Moreover, the second plate 122 has a hook 1221 located on the first surface F1 of the second plate 122, and a gap is formed between the hook 1221 and the main body 110. Specifically, in this embodiment, the hook 1221 is located at one side of the second plate 122 which is far from the first plate 121, thus, the hook 1221 and the first plate 121 are connected with the two opposite side of the first surface F1 of the second plate 122. The hook 1221 is a wall body protruding from the second surface F2 of the second plate 122.

On the other hand, the first plate 121 has a third surface F3, a fourth surface F4 and a lateral surface F5. The third surface F3 and the fourth surface F4 are opposite to each other and the two sides of the lateral surface F5 are connected with the third surface F3 and the fourth surface F4, respectively. The third surface F3 faces toward the main body 110. In this embodiment, the extension section 112 of the main body 110 is connected with the third surface F3 of the first plate 121, and a gap is formed between the third surface F3 of the first plate 121 and the hook 1221.

In this embodiment, the first plate 121 comprises not only at least a second rib 1211 protruding from the fourth surface F4 but also a plurality of third ribs 1212 protruding from the lateral surface F5. In this embodiment, the number of the second rib 1211 is one, and the number of the third ribs 1212 is two. However, the configuration of the fastener 10 comprising the second rib 1211 and the third rib 1212 in the disclosure is not limited thereto.

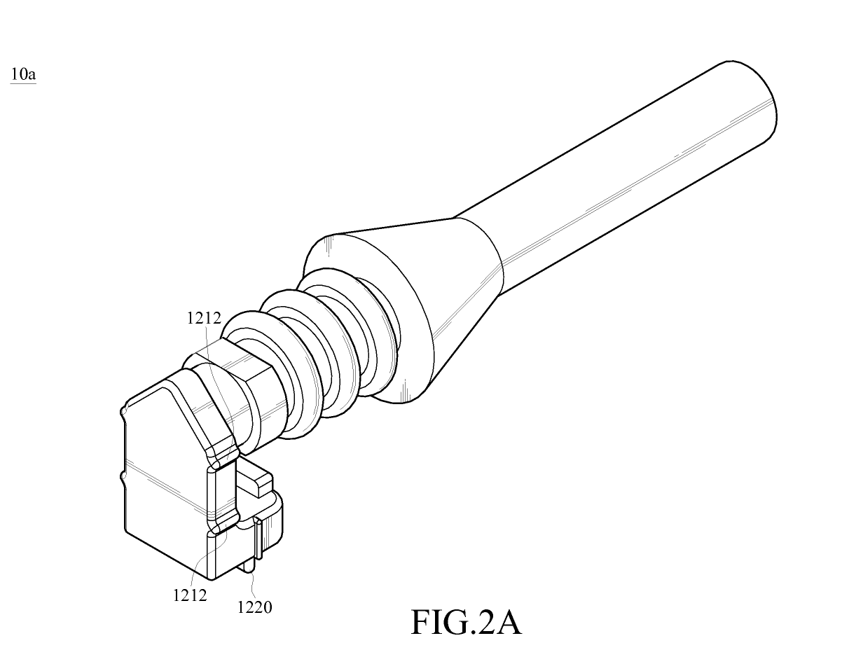

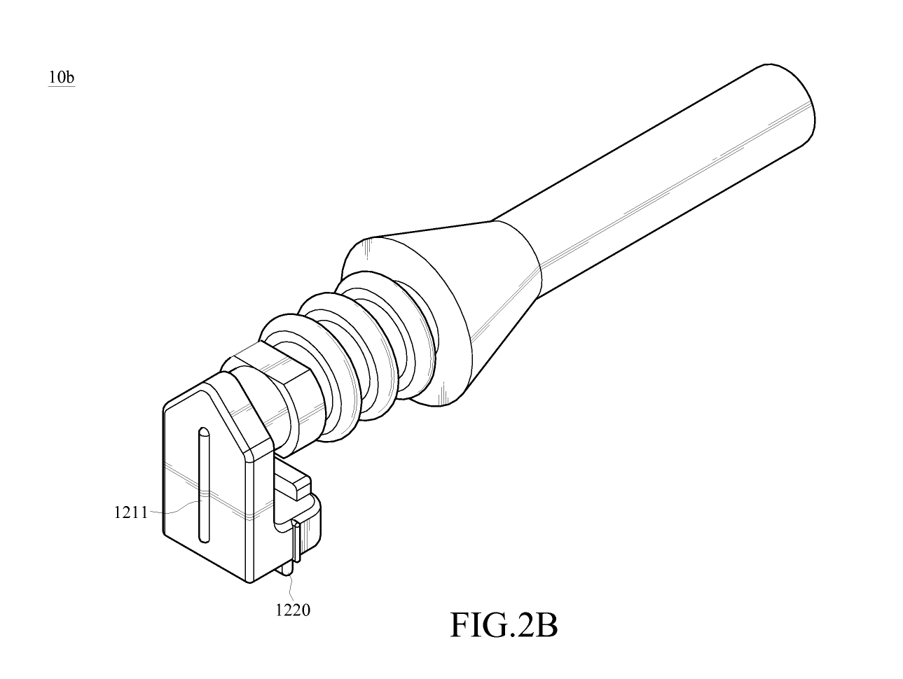

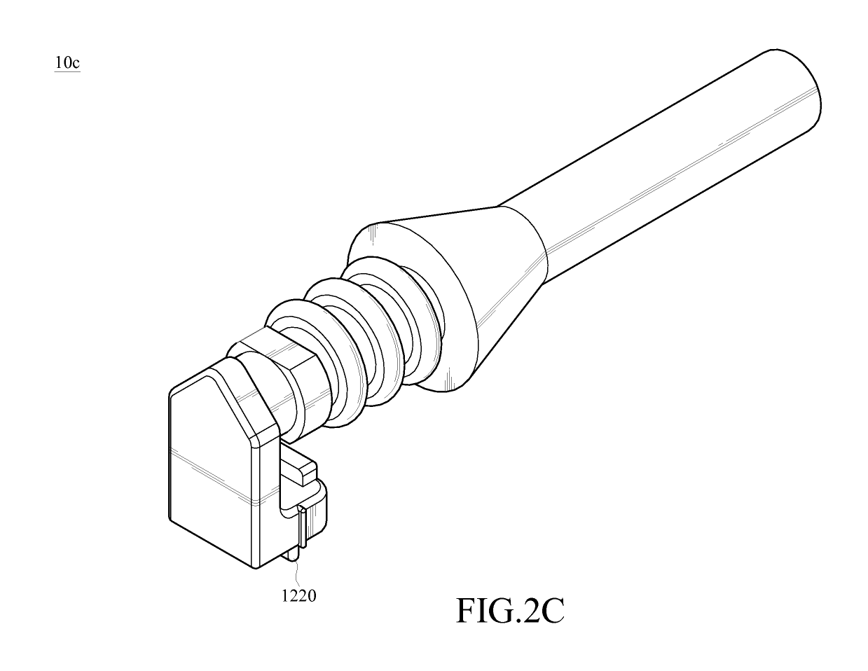

Please refer to the FIG. 2A, FIG. 2B and FIG. 2C, which are perspective views of the fastener according to other embodiments of the disclosure. In some other embodiments of the disclosure, the fastener 10a only has the first rib 1220 and the third rib 1212, and does not comprise the second rib 1211 (as shown in the FIG. 2A), or the fastener 10a only has first rib 1220 and the second rib 1211, and does not comprise the third rib 1212 (as shown in the FIG. 2B). Still, the fastener 10a only has first rib 1220, and does not comprise the second rib 1211 and the third rib 1212 (as shown in the FIG. 2C).

Please refer to the FIG. 1B and FIG. 1C, the second surface F2 of the fastener 10 has a first normal vector V1, the fourth surface F4 has a second normal vector V2 and the lateral surface F5 has a third normal vector V3. In this embodiment, the first normal vector V1, the second normal vector V2 and the third normal vector V3 are orthogonal with each other. Specifically, the first rib 1220 extends from the second surface F2 toward outside along the first normal vector V1, the second rib 1211 extends from the fourth surface F4 toward outside along the second normal vector V2, and the third rib 1212 extends from the lateral surface F5 toward outside along the third normal vector V3.

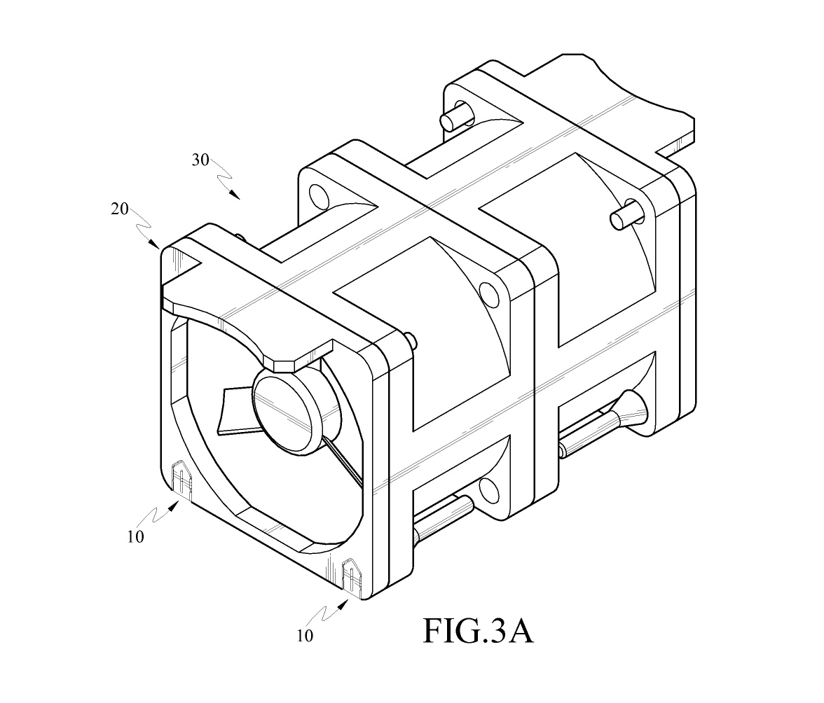

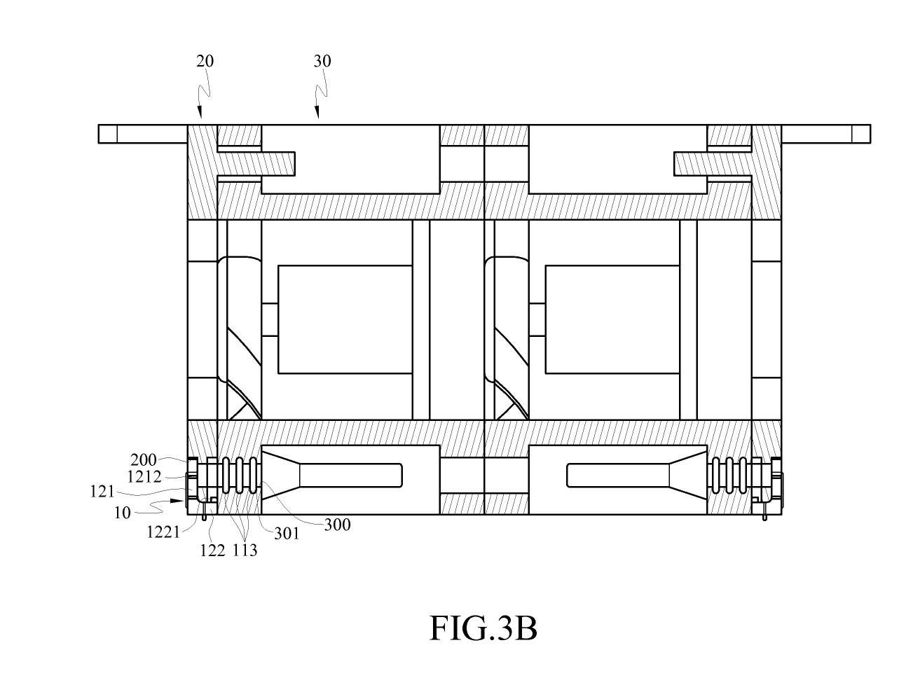

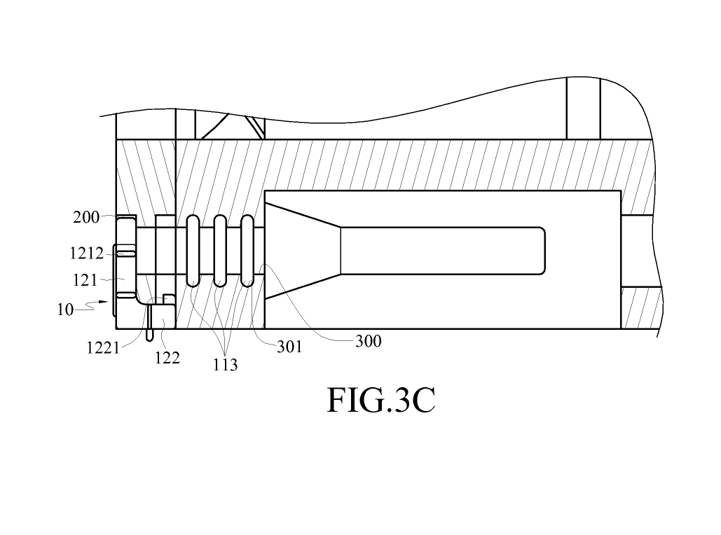

Please refer to the FIG. 1A, FIG. 3A and FIG. 3C. FIG. 3A is a perspective view of a fan assembly according to another embodiment of the disclosure. FIG. 3B is a partially sectional view of the fan assembly described in FIG. 3A. FIG. 3C is a partially enlarged view of the fan assembly described in FIG. 3B. A fan assembly 9 comprises a frame work 20, at least a fan 30 and at least a fastener 10. The structure of the fastener 10 is similar to the above-mentioned description, thus the similar description is not repeated herein again.

The frame work 20 includes at least a perforation 200. The fan 30 is located on the frame work 20. Each of the fans 30 has at least a mounting hole 300 which is corresponded to the at least a perforation 200. In this embodiment, the number of the perforations 200 and the mounting holes 300 is four, but the disclosure is not limited thereto.

The fastener 10 penetrates the perforation 200 and the mounting hole 300 such that the at least a fan 30 is securely located on the frame work 20 by the fastener 10. Specifically, a gap between the hook 1221 of the second plate 122 and the first plate 121 corresponds to the thickness of the frame work 20. On the other hand, an inner surface of the mounting hole 300 includes at least a recess 301, which corresponds to the thread 113 of the main body 110. Therefore, when the fastener 10 sequentially penetrates the perforation 200 and the mounting hole 300, the frame work 20 is located between the hook 1221 of the second plate 122 and the first plate 121, and the at least a thread 113 is engaged with the at least a recess 301, which enables the fan 30 to be securely located on the frame work 20.

In some other embodiments of the disclosure, the third rib 1212 of the second plate 122 is in contact with an inner surface of the perforation 200 of the frame work 20 such that the fastener 10 is contacted with the frame work 20 via the third rib 1212, and a gap is accordingly formed between the lateral surface F5 and the frame work 20, which enables the contact area between the frame work 20 and the fastener 10 to be directly reduced. Therefore, the vibration acted on the lateral surface F5 of the second plate 122 is transferred to the fastener 10 only by the third rib 1212 when the fan 30 operates, which further prevents the energy of vibration generated by the operation of fan 30 from being transferred to the other components inside the fan assembly 9 or the server 7.

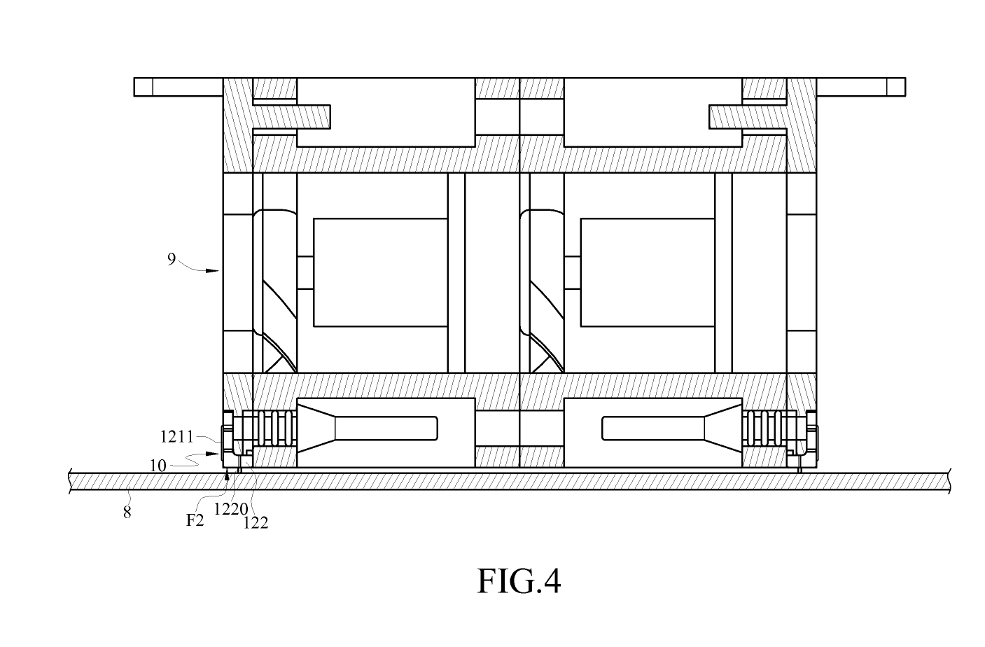

Please refer to the FIG. 1A and the FIG. 4. FIG. 4 is a partially sectional view of a server according to an embodiment of the disclosure.

The server 7 comprises a chassis 8 and a fan assembly 9. The configuration of the fan assembly 9 in this embodiment is similar to that of the embodiment described above, thus the similar description is not repeated herein again. The fan assembly 9 is located on the chassis 8, and the first rib 1220 of the fastener 10 inside the fan assembly 9 faces toward the chassis 8. Specifically, because the fan assembly 9 is mounted on the chassis 8 via the first rib 1220 of the fastener 10, a gap is formed between the chassis 8 and the frame work 20 of the fan assembly 9. Therefore, the contact area between the chassis 8 and the fan assembly 9 is directly reduced. Thus, the vibration acted on the first surface F1 of the second plate 122 is transferred to other components inside the fan assembly 9 or the server only via the first rib 1220 when the fan 30 operates, which further prevents the energy of vibration generated by the operation of fan 30 from being transferred to the other components inside the fan assembly 9 or the server 7. On the other hand, the contact area between the chassis 8 and the fan assembly 9 is directly reduced because the second rib 1211 is in contact with a surface of the chassis 8, which leads to vibration absorption.

According to the embodiment of the fan assembly and the fastener thereof, because the material of the fastener is adapted for vibration absorption, it enables the energy of vibration to be absorbed by the fastener. On the other hand, because the first rib of the fastener is connected with the chassis, a gap is formed between the chassis and the frame work of the fan assembly. Therefore, the contacted area between the chassis and the fan assembly is directly reduced, preventing the energy of vibration generated by the operation of fan from being transferred to the other components inside the fan assembly or the server. Thus, the possibility of failure of the electronic components resulted from the vibration is reduced.

In addition, the first rib extends from the second surface toward outside along the first normal vector, the second rib extends from the fourth surface toward outside along the second normal vector, and the third rib extends from the lateral surface toward outside along the third normal vector. The configurations of the first rib, the second rib and the third rib reduce each of the contacted areas between the fan assembly and the chassis when the fastener is assembled into the fan assembly. Therefore, the components inside the server are avoided to be contacted with the frame work of the fan assembly, which prevents the energy of vibration generated by the operation of fan from being transferred to the other components inside the server.

What is claimed is:

1. A fastener, comprising:
a main body, comprising a protrusion section and an extension section connected with the protrusion section; and
a bending body connected with the extension section of the main body, and the bending body comprising:
a first plate connected with the extension section; and
a second plate connected with the first plate, wherein an angle is formed between the first plate and the second plate, the second plate has a first surface and a second surface which is opposite to the first surface, wherein the first surface faces toward the main body, and the second plate comprises a first rib protruding from the second surface.

2. The fastener according to claim 1, wherein the first plate of the bending body has a third surface, a fourth surface and a lateral surface, wherein the third surface and the fourth surface are opposite to each other and the two sides of the lateral surface are connected with the third surface and the fourth surface, respectively, and the third surface is connected with the main body, wherein the first plate comprises at least a second rib protruding from the fourth surface, and the first plate comprises a plurality of third ribs protruding from the lateral surface.

3. The fastener according to claim 2, wherein the second plate of the bending body has a hook located on the first surface of the second plate, a gap is formed between the hook and the third surface of the first plate, and another gap is formed between the hook and the main body.

4. The fastener according to claim 2, wherein the extension section of the main body is connected with the third surface of the first plate, and at least a thread protrudes from a surface of the extension section.

5. The fastener according to claim 2, wherein the second surface has a first normal vector, the fourth surface has a second normal vector and the lateral surface has a third normal vector, wherein the first normal vector, the second normal vector and the third normal vector are orthogonal with each other.

6. The fastener according to claim 1, wherein the material of the fastener is adapted for vibration absorption.

7. A fan assembly, comprising:
a frame work having at least a perforation;
at least a fan located on the frame work, each of the fans has at least a mounting hole which is corresponded to the at least a perforation; and
a fastener penetrating the perforation and the mounting hole such that the at least a fan is securely located on the frame work, and the fastener comprising:
a main body, comprising a protrusion section and an extension section connected with the protrusion section; and
a bending body connected with the extension section of the main body, and the bending body comprising:
a first plate connected with the extension section; and
a second plate connected with the first plate, wherein an angle is formed between the first plate and the second plate, the second plate has a first surface and a second surface which is opposite to the first surface, wherein the first surface faces toward the main body, and the second plate comprises a first rib protruding from the second surface.

8. The fan assembly according to claim 7, wherein the first plate of the bending body has a third surface, a fourth surface and a lateral surface, wherein the third surface and the fourth surface are opposite to each other and the two sides of the lateral surface are connected with the third surface and the fourth surface, respectively, and the third surface is connected with the main body, wherein the first plate comprises at least a second rib protruding from the fourth surface, and the first plate comprises a plurality of third ribs protruding from the lateral surface, wherein the second plate of the bending body has a hook located on the first surface of the second plate, a gap is formed between the hook and the third surface of the first plate, and another gap is formed between the hook and the main body, wherein the frame work is located between the hook and the first plate.

9. The fan assembly according to claim 8, wherein the extension section of the main body is connected with the third surface of the first plate, and at least a thread protrudes from a surface of the extension section, wherein an inner surface of the mounting hole includes at least a recess, and the at least a thread is engaged with the at least a recess.

10. The fan assembly according to claim 8, wherein the second surface has a first normal vector, the fourth surface has a second normal vector and the lateral surface has a third normal vector, wherein the first normal vector, the second normal vector and the third normal vector are orthogonal with each other.
